(19) United States
(12) Patent Application Publication
(10) Pub. No.: US 2007/0147060 A1
(43) Pub. Date: Jun. 28, 2007

(54) Headlight driving device

(76) Inventor: Wei-Jen Chen, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/288,364

(22) Filed: Nov. 29, 2005

(51) Int. Cl. F21V 17/02

(52) U.S. Cl. 362/513

(57) ABSTRACT

A head light driving device includes a light set and a driving set which is connected to the light set and includes a motor for driving a driving part via a gear reduction set. An assistant gear is engaged with the gear reduction set and has a magnet. A circuit board has a detection member for detecting change of magnetic field of the magnet. A driving shaft is connected between the light set and the driving part. The numbers of teeth of the assistant gear and the fan-shaped rack of the driving part have a certain ratio so that the fan-shaped rack can be rotated precisely to a desired angle when the driving part rotates a small angle.

### FIELD OF THE INVENTION

The present invention relates to a vehicle head light driving device, and more particularly, to a driving device which drives the head light more precisely.

### BACKGROUND OF THE INVENTION

A conventional head light driving device 1 used for an Adaptive Front-Lighting System (AFS) is shown in FIG. 1 and generally includes a motor 2, a gear reduction set 3, a driving part 4, a circuit board 5 and a driving shaft 6. The output shaft 21 of the motor 2 has a driving gear 22 which is engaged with the gear reduction set 3 which is engaged with a fan-shaped rack 41 of the driving part 4. A magnet 42 with N and S poles is connected to a first end of the driving part 4 and a second end of the driving part 4 is connected with the driving shaft 6. The circuit board 5 has a detection member 51 which is located corresponding to the magnet 42.

When the driving device 1 is operated, the detection member 51 detects the change of magnetic field due to the rotation of the magnet 42 on the driving part 4 so as to decide the real position of the driving shat 6 and the real position is compared with a pre-set position. If the real position and the pre-set position are different, the motor 2 drives the gear reduction set 3 and rotates the driving shaft 6 to the pre-set position.

However, it is noted that the detection member 51 may detect the change of angle to 0.1 degree, the driving part 4 can only rotate to 1 degree due to the ratio of the gears of the gear reduction set 3. Therefore, the driving part 4 cannot rotate 0.1 degree which is not precise enough to meet the detection of the detection member 51. Besides, the range of the rotation of the head light is from +15 to −5 degrees, when the driving part 4 is rotated −5 degrees, because the driving part 4 can only rotate as small as one degree, so that when the detection member 51 detects that the real position is different form the pre-set position, and a command is sent to rotate the driving part 4 4.5 degrees, the driving part 4 might rotate 5 degrees or only rotate 4 degrees. This makes the head light to be operated not as precisely as expected.

The present invention intends to provide a head light driving device that drives the head light at small angle so that the head light can be operated as required.

### SUMMARY OF THE INVENTION

The present invention relates to a head light driving device which comprises a light set and a fixing part for fixing the light set. A driving set is connected to the light set and includes a motor for being engaged with a gear reduction set which includes a first gear and a second gear. A driving part has a fan-shaped rack which is engaged with the gear reduction set. An assistant gear is engaged with the gear reduction set and a magnet with N and S poles is connected to a first end of the assistant gear. A driving shaft is connected between the light set and a second end of the driving part. A circuit board has a detection member which detects change of magnetic field of the magnet. A case receives the driving part, the gear reduction set, the assistant gear and the circuit board therein. The motor is located at outside of the case.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional head light driving device;

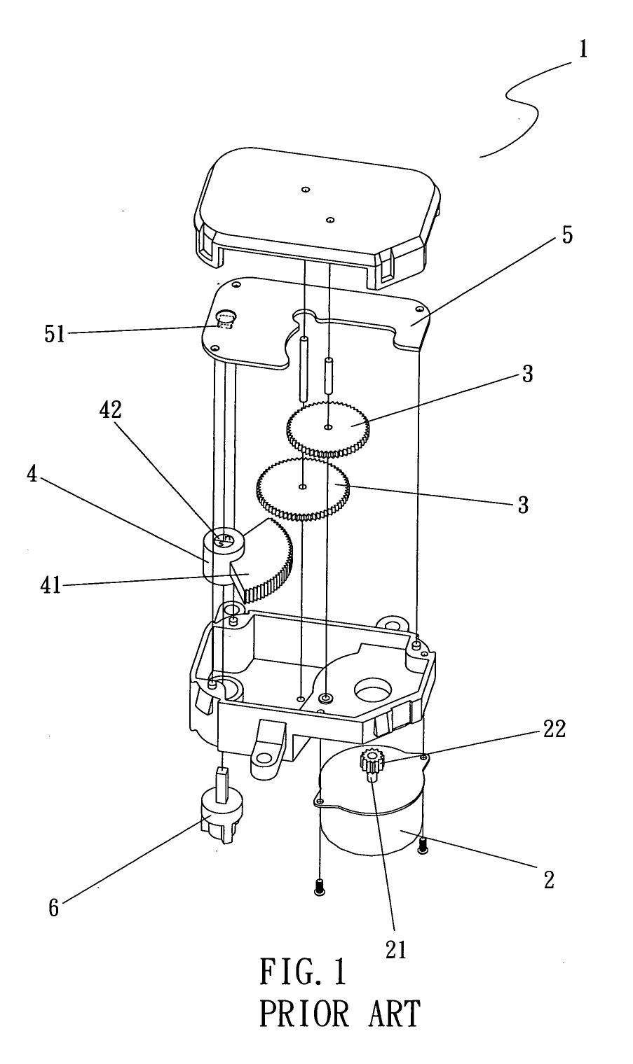

FIG. 2 is a perspective view to show the driving device of the present invention;

FIG. 3 is a cross sectional view to show the driving device of the present invention;

FIG. 4 is an exploded view to show the driving device of the present invention;

FIG. 5 is an exploded view to show the driving set of the driving device of the present invention, and

FIG. 6 shows the engagement of gears of the driving set of the present invention.

### DETAILED DESCRIPTION OF THE PREFERRED EMBODIMENT

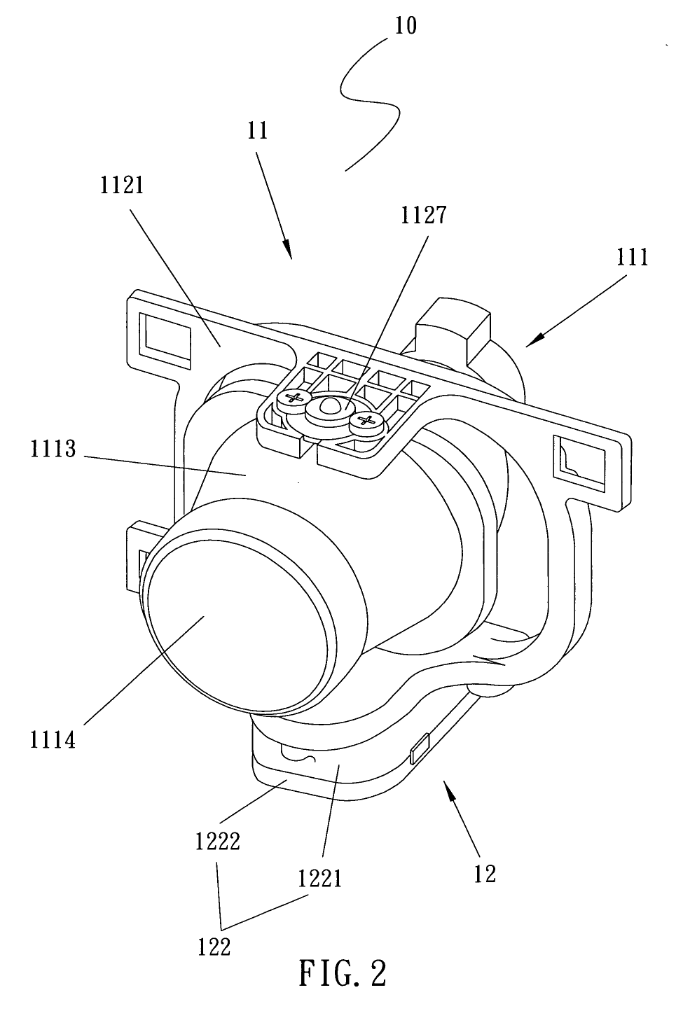

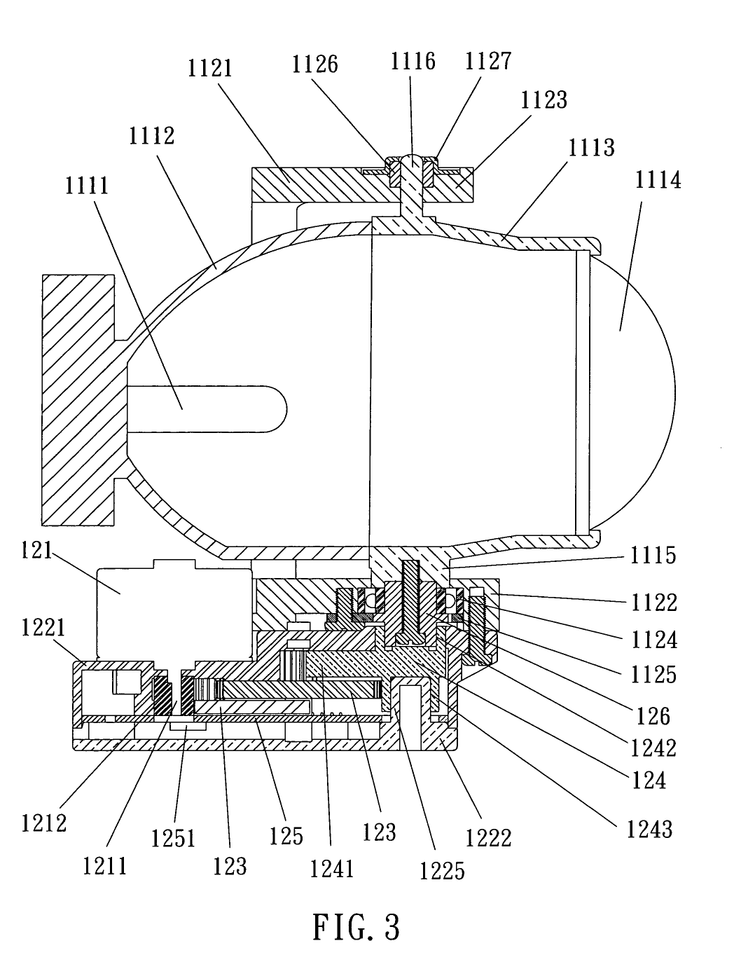

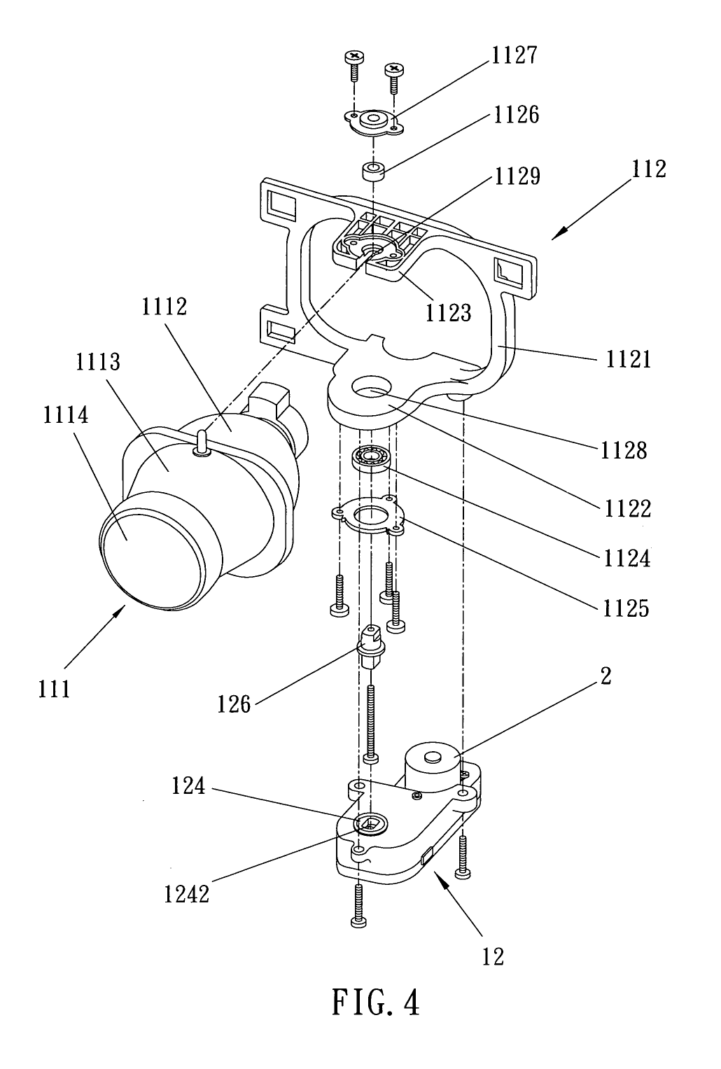

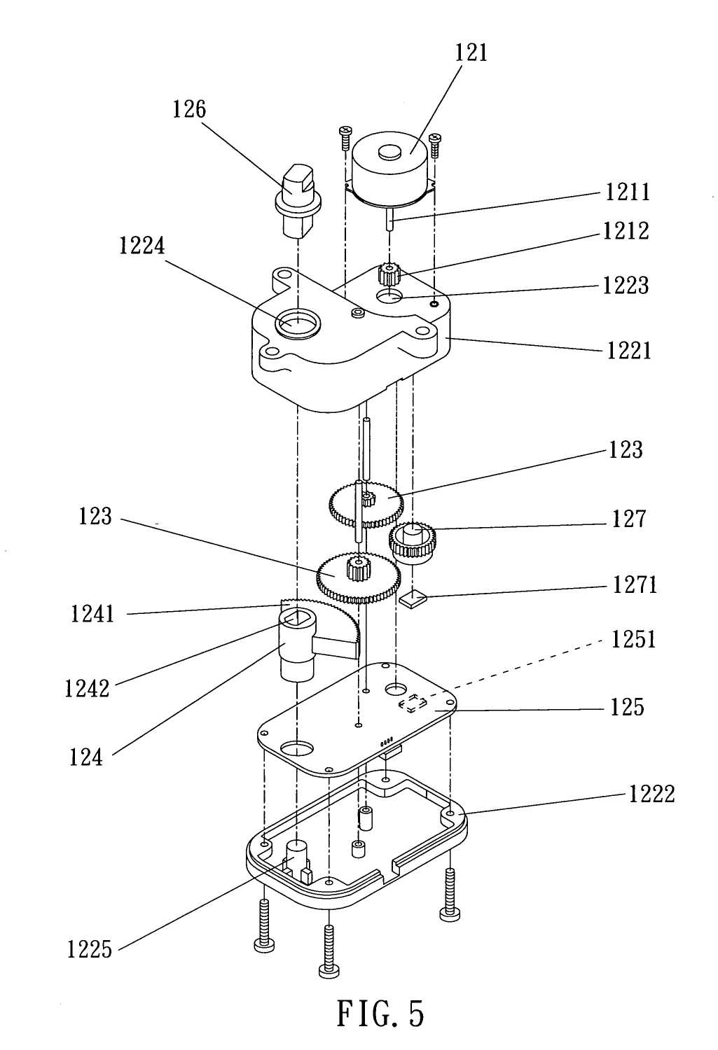

Referring to FIGS. 2 to 6, the head light driving device 10 of the present invention comprises a light source 11 which includes a light set 111 and a fixing part 112 for fixing the light set 111. The light set 111 includes a bulb 1111, a reflection member 1112 with the bulb 1111 located at a focus of the curvature of the reflection member 1112, a tube 1113 has one end connected to the reflection member 1112 and a lens 1114 connected to the other end of the tube 1113. A fixing member 1115 is connected to an underside of the tube 1113 and fixed to the driving shaft 126 of a driving set 12, and a rod 1116 is connected to a top of the tube 1113.

The fixing part 112 includes a rectangular frame 1121 which has a first protrusion 1122 extending perpendicularly from a lower end thereof and a bearing 1124 is received in a hole 1128 defined through the first protrusion 1122. A first positioning plate 1125 is fixed on the underside of the first protrusion 1122 to position the bearing 1124 in the hole 1128. A second protrusion 1123 extends perpendicularly from a top end thereof and a fixing collar 1126 is engaged with another hole 1129 defined in the second protrusion 1123. A second positioning plate 1127 is fixed on a top of the second protrusion 1123 to position the fixing collar 1126. The driving shaft 126 of the driving set 12 extends through the bearing 1124 and the rod 1116 on the tube 1113 extends through the fixing collar 1126 so that the light set 111 is pivotably connected to the rectangular frame 1121.

The driving set 12 is connected to the light set 111 and includes a case 122 for receiving a driving part 124, a gear reduction set 123, an assistant gear 127 and a circuit board 125 therein. A motor 121 is located at outside of the case 122 and includes a driving gear 1212 connected to an output shaft 1211 of the motor 121. The case 122 is composed of an upper part 1221 and a bottom part 1222. The upper part 1221 includes a receiving space for receiving all the parts of the driving set 12 and a first aperture 1223 and a second aperture 1224 are defined through the upper part 1221. The output shaft 1211 extends through the first aperture 1223 and the driving part 124 extends through the second aperture 1224. A connection rod 1225 extends from an inside of the bottom part 1222. The driving part 124 has a fan-shaped rack 1241.

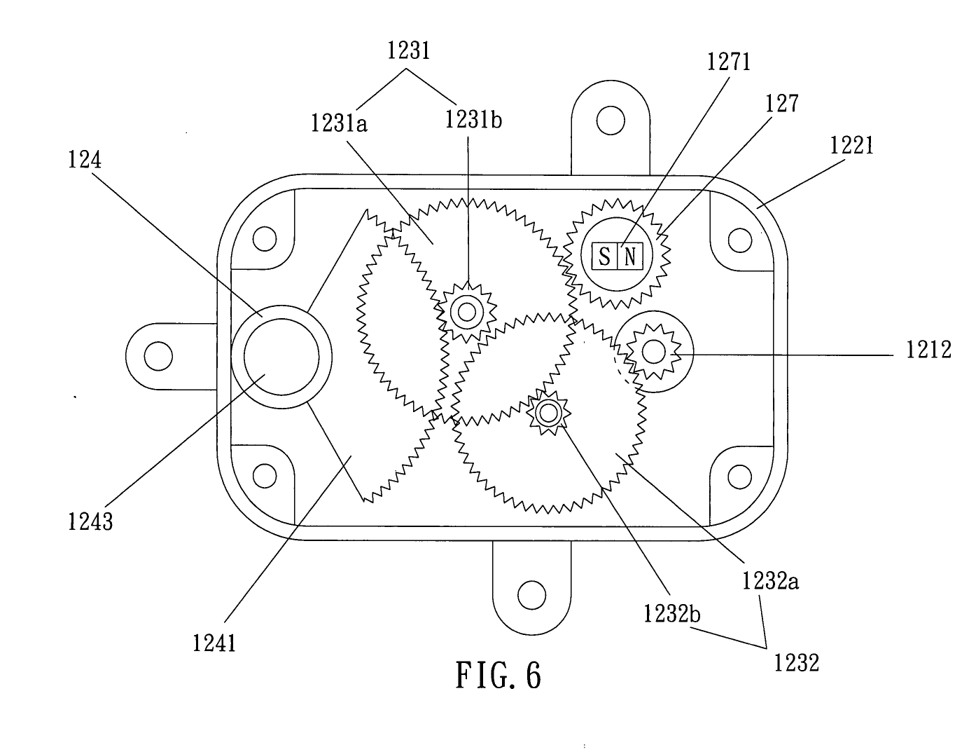

The gear reduction set 123 has a first gear 1231 and a second gear 1232 as shown in FIG. 6, the first and second gears 1231, 1232 have different numbers of teeth. The first gear 1231 is composed of a first upper gear 1231a and a first bottom gear 1231b, and the second gear 1232 is composed of a second upper gear 1232a and a second bottom gear 1232b. The second upper gear 1232a is engaged with the first bottom gear 1231b, and the driving gear 1212 of the output shaft 1211 is engaged with the second upper gear 1232a. The first bottom gear 1231b is engaged with the fan-shaped rack 1241 of the driving part 124. An assistant gear 127 is engaged with the first upper gear 1231a of the gear reduction set 123. A magnet 1271 is connected to a first end of the assistant gear 127 and the magnet 1271 has an N pole and an S pole.

The circuit board 125 has a hole through which a first end of the driving part 124 extends and the first end of the driving part 124 has a notch 1243 for receiving the connection rod 1225 on the bottom part 1222 of the case 12. A detection member 1251 which detects change of magnetic field of the magnet 1271 when the assistant gear 127 rotates. The driving shaft 126 is connected between the light set 111 and another notch 1242 in a second end of the driving part 4. The assistant gear 127 and the fan-shaped rack 1241 have different numbers of teeth, a number of revolutions of the assistant gear 127 is a product of an angle that the fan-shaped rack 1241 rotates times a ratio.

When the motor 121 rotates, the first and second gears 1231, 1232 and the assistant gear 127 are rotated by the driving gear 121. The fan-shaped rack 1241 of the driving part 124 is rotated by the first bottom gear 1231b. The driving shaft 126 is fixed to the driving part 124 so that the driving shaft 126 is rotated which drives the light source 11 so that the light set 111 is co-rotated with the rotation of the driving part 124.

When the assistant gear 127 rotates, the detection member 1251 detects the change of the magnetic field of the magnet 1271 of the assistant gear 127. The change of the magnetic field is calculated by the circuit to decide the angle that the assistant gear 127 rotates. The angle that the assistant gear 127 rotates can be obtained by the formula:
Ratio=(number of teeth of gear A/number of teeth of gear B)×(number of teeth of gear C/number of teeth of gear D)

In this embodiment, the gear “A” is the fan-shaped rack 1241 which has 77 teeth, the gear “B” is the second bottom gear 1232b of the second gear 1232, wherein the second bottom gear 1232b has 12 teeth. The gear “C” is the second upper gear 1232a of the second gear 1232, which has 60 teeth. The gear “D” is the assistant gear 127 which has 25 teeth. The ratio will be (77/12)×(60/25)=15.4. If the range of rotation of the driving part 124 is between +15 to −5 degrees, and the range of rotation of the assistant gear 127 is between +231 to −77 degrees, the range of rotation of the assistant gear 127 can be evenly divided into several units when calculating, and the even units are the pre-set values of the calculation and the the angles of rotation. Therefore, the circuit can precisely control the angle that the output shaft 1211 of the motor 121 by the ratio between the assistant gear 127 and the fan-shaped rack 1241 of the driving part 124. The fan-shaped rack 1241 can precisely rotate to the desired angle.

While we have shown and described the embodiment in accordance with the present invention, it should be clear to those skilled in the art that further embodiments may be made without departing from the scope of the present invention.

What is claimed is:

1. A head light driving device comprising:
a light source which includes a light set and a fixing part for fixing the light set;
a driving set connected to the light set and including a motor which includes a driving gear connected to an output shaft of the motor;
a driving part having a fan-shaped rack;
a gear reduction set having a first gear and a second gear, the first and second gears having different numbers of teeth, the gear reduction set being engaged with the driving gear of the driving set and the fan-shaped rack of the driving part;
an assistant gear engaged with the gear reduction set and a magnet connected to a first end of the assistant gear, the magnet having an N pole and an S pole;
a circuit board having a detection member which detects change of magnetic field of the magnet;
a driving shaft connected between the light set and a second end of the driving part, and
a case for receiving the driving part, the gear reduction set, the assistant gear and the circuit board therein, the motor located at outside of the case.

2. The device as claimed in claim 1, wherein light set has a bulb, a reflection member, a tube, and a lens, the bulb is connected to the reflection member and the tube is located between the reflection member and the lens, a fixing member is connected to an underside of the tube and fixed to the driving shaft, a rod is connected to a top of the tube.

3. The device as claimed in claim 1, wherein the fixing part includes a frame which has a first protrusion extending perpendicularly from a lower end thereof and a bearing is received in a hole defined through the first protrusion, a second protrusion extends perpendicularly from a top end thereof and a fixing collar is engaged with another hole defined in the second protrusion, the driving shaft of the driving set extends through the bearing and the rod on the tube extends through the fixing collar.

4. The device as claimed in claim 1, wherein the assistant gear and the fan-shaped rack have different numbers of teeth, a number of revolution of the assistant gear is a product of an angle that the fan-shaped rack rotates times a ratio.

5. The device as claimed in claim 4, wherein a range of that the assistant gear rotates is divided into a plurality of even units which are pre-set values of an operation of the circuit and angles to rotate so as to control the driving part to rotate within a small angle.
